(19) United States
(12) Patent Application Publication
(10) Pub. No.: US 2008/0193089 A1
(43) Pub. Date: Aug. 14, 2008

(54) OPTICAL CONNECTOR CONNECTING METHOD AND STRUCTURE

(75) Inventors: Masaaki MIYAMOTO, Sakura-shi (JP); Yoshinori IWASHITA, Sakura-shi (JP); Noriyuki KAWANISHI, Sakura-shi (JP); Kazuhiro TAKIZAWA, Sakura-shi (JP); Toshiki KUBO, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIKURA LTD., Tokyo (JP)

(21) Appl. No.: 12/029,867

(22) Filed: Feb. 12, 2008

(30) Foreign Application Priority Data
Feb. 13, 2007 (JP) 2007-032617

(51) Int. Cl. G02B 6/255

(52) U.S. Cl. 385/96

(57) ABSTRACT

A method and apparatus of connecting an optical connector and an optical fiber cord are provided. The method includes providing the optical connector, a connector housing, a stop-ring structure, and an optical fiber; fusion-splicing a fiber end of the optical fiber of the optical connector and a fiber end of an optical fiber protruding from a cord end of an optical fiber cord; enclosing the cord end of the optical fiber cord and at least the stop-ring structure end. The sleeve includes an annular sleeve body, a hot melt resin layer applied to an inner surface of the sleeve body, a tensile-strength body embedded in the sleeve body or the hot melt resin layer. The sleeve is heated such that the hot melt resin layer is melted into molten resin which in turn fills the inner space of the sleeve and solidifies therein.

### CROSS-REFERENCE TO RELATED APPLICATIONS

This application claims priority from Japanese Patent Application No. 2007-032617, filed on Feb. 13, 2007 in the Japanese Patent Office, the disclosures of which is incorporated herein by reference.

### BACKGROUND OF THE INVENTION

1. Field of the Invention

Apparatuses and methods consistent with the present invention relate to an optical connector connecting method and a structure produced by using the same, and more specifically to a method and a structure connecting an optical fiber of an optical connector and an optical fiber of an optical fiber cord.

2. Description of the Related Art

In the related art, as a fused connection structure in which an optical fiber of an optical connector and an optical fiber cord are connected by fusion, the structure (1) in which a bare optical fiber extended from a fine hole of a ferrule and an optical fiber are fused outside the ferrule and the thus-fused connection portion is covered with a heat-shrinkable tube (see, e.g., Japanese Patent Application, First Publication No. 64-18113); the structure (2) in which optical fibers are inserted from opposed directions into an optical connector and then the tip ends thereof are fused inside a hollow portion of the optical connector (see, e.g., U.S. Pat. No. 5,748,819); and the structure (3) in which an optical fiber extended from an optical connector and an optical fiber of an optical fiber cable are connected and reinforced by a reinforcing tube (see, e.g., U.S. Pat. No. 6,152,609) have been proposed.

In the above-described, related art structure (1), a bare optical fiber extending outside is inserted in a heat-shrinkable tube and then the bare optical fiber and an optical fiber are fused or spliced, and thereafter, the heat-shrinkable tube is heated to contract. There is an inconvenience in that an existing fusion-splicing apparatus cannot be used and thus, a new apparatus dedicated therefor is necessary.

Furthermore, in this related art structure, when a sheath or cover of the optical fiber cord is removed or peeled, a process for aramid fiber is necessarily carried out, thereby resulting in an improperly long processing time.

In the above-described, related art structure (2), because a connection point is maintained in a hollow portion of an optical connector, when external force acts thereon, there is a drawback in that the force is transmitted to the connection point.

Furthermore, when the tips of optical fibers are fused or connected, electrical discharging is necessarily carried out in response to the widths of slits. Thus, a dedicated fusion-splicing apparatus is necessary.

In this structure, when a sheath or cover of the optical fiber is removed or peeled, a process for aramid fiber is necessarily carried out, thereby resulting in an improperly long processing time.

In the above-identified, related art structure (3), because the structure is such that a connection point is protected by a reinforcing tube, the number of processes is increased and thereby the production cost is increased. An existing fusion-splicing apparatus is not suited therefor or cannot be used. Thus, a new apparatus dedicated thereto is separately necessary.

Further, it is necessary for aramid fiber to be precisely cut to a predetermined length for the insertion of the aramid fiber. It becomes necessary to provide a special tool dedicated for the insertion thereof. There becomes a clearance which is inevitably produced between the aramid fiber and the optical fiber.

### SUMMARY OF THE INVENTION

Exemplary embodiments of the present invention provide an optical connector connecting method and a structure produced by the method, as a result of which, when an optical fiber of an optical connector and an optical fiber of an optical fiber cord are fusion-spliced, a clearance between a connection portion and a reinforcing sleeve is not generated such that they are firmly fixed to one another and that handling is easy and the production cost can be decreased.

According to a first aspect of the present invention, there is provided a method of connecting an optical connector and an optical fiber cord, comprising: providing the optical connector which includes a connector housing, a stop-ring structure, an optical fiber extending through the preceding two members and protruding from a structure end of the stop-ring structure toward the connection side; fusion-splicing a fiber end of the optical fiber of the optical connector and a fiber end of an optical fiber protruding from a cord end of the optical fiber cord; enclosing the cord end of the optical fiber cord and at least the structure end of the stop-ring structure so as to bridge them, wherein the reinforcing sleeve includes an annular sleeve body, a hot melt resin layer annexed to an inner surface of the sleeve body, a tensile-strength body embedded in the sleeve body or the hot melt resin layer; and heating and heat-releasing the reinforcing sleeve such that the hot melt resin layer is melted into molten resin which in turn fills the inner clearance of the reinforcing sleeve and then solidified therein to thereby achieve an integral combination of said code end of the optical fiber cord and the stop-ring structure with a sufficient strength.

The tensile-strength body may extend parallel with an axis of the sleeve body from end to end thereof.

The optical fiber of the optical connector may be fixedly secured to an inner portion of the structure end of the stop-ring structure.

The optical fiber cord may comprise tensile-strength fiber bodies which extend through the reinforcing sleeve toward the stop-ring structure but do not reach the stop-ring structure.

At least one concave portion and/or convex portion may be formed on an outer peripheral surface of the stop-ring structure.

According to a second aspect of the present invention, there is provided an optical connection that is formed by the method as recited in the first aspect of the present invention.

The above and other aspects of the present invention will become apparent upon consideration of the following detailed descriptions of exemplary embodiments thereof, particularly when taken in conjunction with the accompanying drawings wherein like reference numerals in the various figures are utilized to designate like components.

### BRIEF DESCRIPTION OF THE DRAWINGS

FIG. 1 is a cross sectional view illustrating an optical connector of an exemplary embodiment of the present invention.

FIG. 2 is a cross sectional view along the line A-A of FIG. 1.

FIG. 3 is a cross sectional view along the line B-B of FIG. 1.

FIG. 4 is a diagram illustrating a relationship between the length of an aramid fibre and the breaking strength of an optical fiber.

FIG. 5 is a view illustrating a step of making the optical connector of an exemplary embodiment of the present invention.

FIG. 6 is a view illustrating a step of making the optical connector of an exemplary embodiment of the present invention.

FIG. 7 is a view illustrating a step of making the optical connector of an exemplary embodiment of the present invention.

FIG. 8 is a view illustrating a step of making the optical connector of an exemplary embodiment of the present invention.

FIG. 9 is a view illustrating a step of making the optical connector of an exemplary embodiment of the present invention.

FIG. 10 is a cross sectional view along the line C-C of FIG. 9.

FIG. 11 is a cross sectional view along the line D-D of FIG. 9.

FIG. 12 is a view illustrating a step of making the optical connector of an exemplary embodiment of the present invention.

FIG. 13 is a cross sectional view illustrating a modified example of the tensile-strength fiber body 11 before heat shrinkage of the aforesaid embodiment.

FIG. 14 is a cross sectional view illustrating a modified example of the tensile-strength fiber body 11 before heat shrinkage of the aforesaid embodiment.

FIG. 15 is a cross sectional view illustrating a modified example of the tensile-strength fiber body 11 before heat shrinkage of the aforesaid embodiment.

FIG. 16 is a cross sectional view illustrating a modified example of the tensile-strength fiber body 11 before heat shrinkage of the aforesaid embodiment.

FIG. 17 is a side view illustrating a modified example of the stop-ring structure of the aforesaid embodiment.

FIG. 18 is a side view illustrating a modified example of the stop-ring structure of the aforesaid embodiment.

FIG. 19 is a side view illustrating a modified example of the stop-ring structure of the aforesaid embodiment.

FIG. 20 is a side view illustrating a modified example of the stop-ring structure of the aforesaid embodiment.

FIG. 21 is a side view illustrating a modified example of the stop-ring structure of the aforesaid embodiment.

### DETAILED DESCRIPTION OF EXEMPLARY EMBODIMENTS OF THE INVENTION

A description will now be given of exemplary embodiments relating to a structure and a method of connecting an optical fiber of an optical connector and an optical fiber cord. Note that it is concretely described for better understanding of the gist of the invention and that it is not limiting of the present invention.

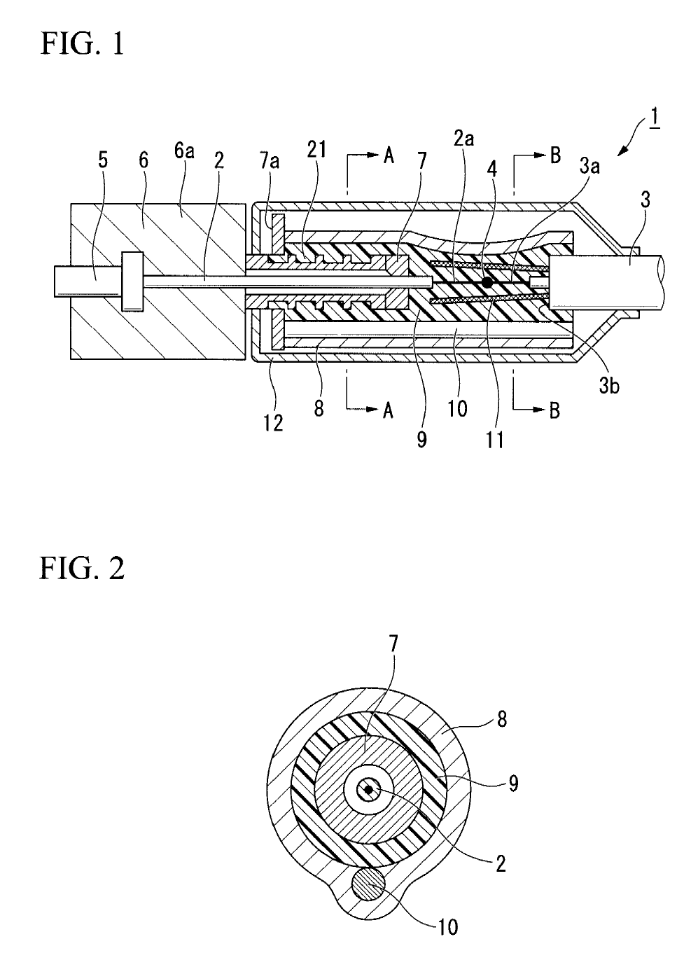

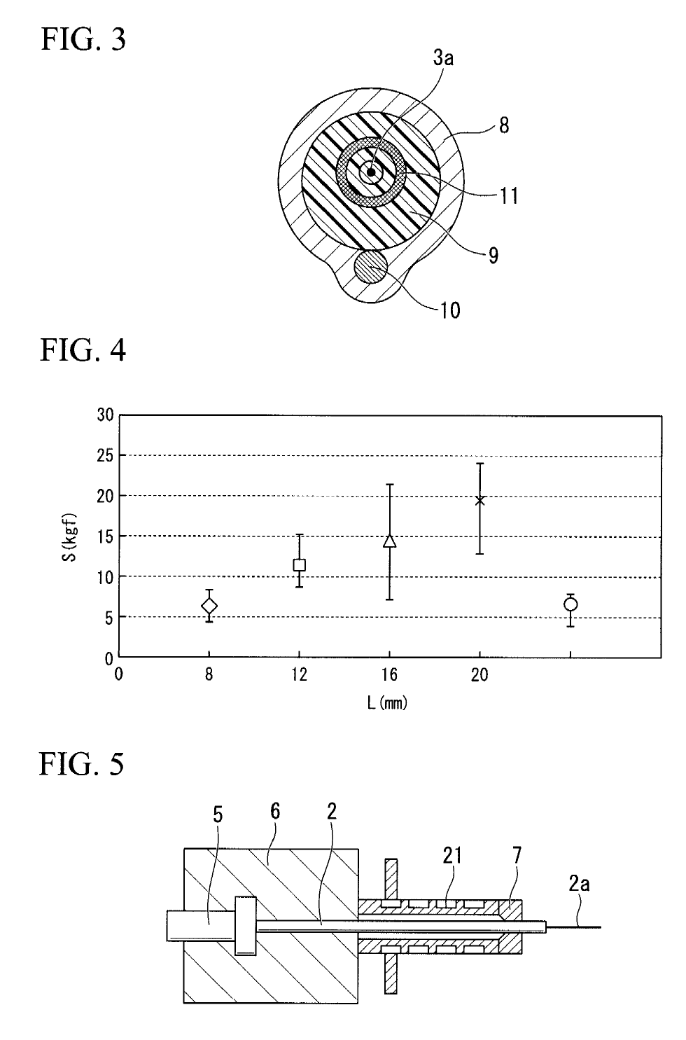

FIG. 1 is a cross sectional view illustrating an optical connector of an exemplary embodiment of the present invention. FIG. 2 is a cross-sectional view along the line A-A of FIG. 1. FIG. 3 is a cross sectional view along the line B-B of FIG. 1. In these figures, 1 denotes an optical connector connecting apparatus which includes a fused connection portion 4 in which a bare optical fiber 2a of an optical fiber 2 extending with a predetermined protruding length from an optical connector 6 and a bare optical fiber 3a of an optical fiber cord 3 are fused-connected.

Referring again to these figures, 5 denotes a ferrule into which the optical fiber 2 of the optical connector 6 is inserted, 6a denotes a connector housing in which the ferrule 5 is secured, 7 denotes a stop-ring structure which abuts one end of the connector housing 6a, 8 denotes a reinforcing sleeve which has a cylindrical shape and encloses the stop-ring structure 7 in such a manner that one end of the reinforcing sleeve 8 contacts the flange 7a of the stop-ring structure 7, 9 denotes a hot melt resin with which the inside of the reinforcing sleeve 8 is filled, 10 denotes a tensile-strength body (strain relief element) which is disposed so as to be substantially parallel with an axis of the optical fiber 2 of the optical connector 6 and with an axis of the optical fiber cord 3 and wherein one end of the tensile-strength body 10 contacts (the flange 7a of) the stop-ring structure 7, 11 denotes tensile-strength resins (strain relief element) which enclose the bare optical fibers 2a and 3a and the fused connection portion 4, and 12 denotes a boot which is comprised of a cylindrical casing.

The stop-ring structure 7 is formed with a plurality of grooves 21 which circumferentially extend in parallel with one another and in which the hot melt resin 9 fills. The dimensions such as width, depth, interval and the like, of these grooves 21 are set such that, when the stop-ring structure 7 is covered with the reinforcing sleeve 8, it can sustain a longitudinal stress. Generally, they are set so that the strength thereof is maximized. In an exemplary embodiment, when the stop-ring structure 7 has a diameter of 4 mm and a length of 8 mm and the reinforcing sleeve 8 has a length of 34 mm, the width, the depth and interval of each groove 21 are set to be 2 mm, 2 mm, and 1.5 mm, respectively.

The optical fiber 2 of the optical connector 6 is secured with adhesive to a free end side of the stop-ring structure 7. Due to this, it is possible for the optical fiber 2 of the optical connector 6 to be positionally secured or determined. Accordingly, a chance of the optical fiber 2 of the optical connector 6 protruding out from the stop-ring structure 7, which is one of the related art drawbacks, when an external force acts on the optical fiber 2 of the optical connector 6, can be eliminated.

The reinforcing sleeve 8 is made of a heat-shrinkable material or plastic, which becomes smaller when heated to a predetermined temperature or more. Polyethylene (shrinkage temperature: 100 to 120 degrees centigrade), for example, can be used. The reinforcing sleeve 8 encloses or encircles most of the stop-ring structure 7 or at least a structure portion extending from the flange 7a.

The hot melt resin 9 is a resin member obtained by providing a composite element (precursor) or raw material; heating it to a predetermined temperature or more; transforming it into any desired shape; cooling it to a preselected temperature or lower than the predetermined temperature; and curing it. Considering the workability and the like, the resin member may be melted at a temperature which is roughly equal to or comes near the shrinkage temperature of the reinforcing sleeve 8. As an example of the resin member, EVA resin (melting temperature: 90 to 100 degrees centigrade) or the like may be used.

The tensile-strength body 10 has, for example, a rod shape and is made of stainless steel or the like. It can relieve strain acting on the bare optical fibers 2a and 3a and the fused connection portion 4 due to an external force and thereby prevent the optical fibers from bending.

The tensile-strength fiber body 11 is made of, for example, aramid fiber, which is superior in tensile strength. It can relieve strain acting on the bare optical fibers 2a and 3a or on and around the fused connection portion 4 at the time of heat shrinkage of the reinforcing sleeve 8 and of hardening or setting of the hot melt resin 9 and thereby protect them.

FIG. 4 is a diagram illustrating a relationship between the length L of the tensile-strength fiber body 11 from the end of the optical fiber cord 3 body to the tip end and the breaking strength S (kgf) of an optical fiber. FIG. 4 reveals that, unless the aramid fiber 11 reaches the stop-ring structure 7, the longer the aramid fiber length (L) is, the stronger it is in terms of breakage. When the aramid fiber 11 reaches the stop-ring structure 7, the strength thereof is decreased. Thus, in an exemplary embodiment the length of the (exposed) tensile-strength fiber body 11 or aramid fiber length L may be 8 mm to 20 mm, or about 20 mm.

Next, a description of an exemplary embodiment will be given, with reference to FIGS. 5 to 12, of a process to produce the aforesaid optical connector connecting apparatus 1.

Firstly, as illustrated in FIG. 5, an outer side surface (or left-hand side surface in FIG. 5) of the optical fiber 2 is polished together with the ferrule 5. Thereafter, an inner side section (or right-hand side section in FIG. 5) of the optical fiber 2 is decoated and cut to provide an exposed bare optical fiber 2a having a predetermined protruding length for fusion splicing.

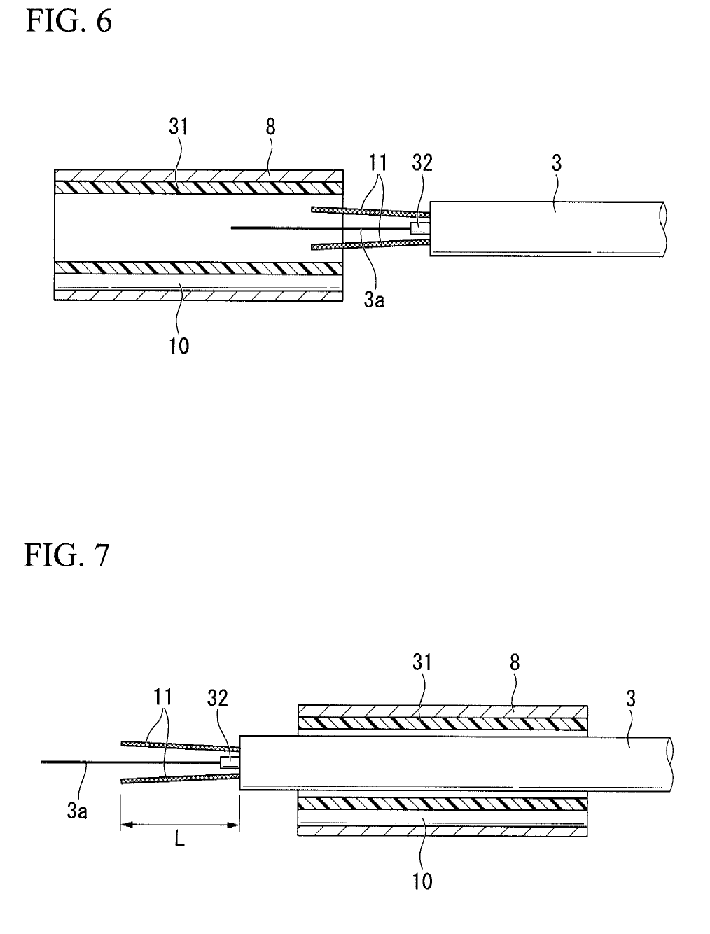

Thereafter or therebefore, as illustrated in FIG. 6, to provide the reinforcing sleeve 8, the tensile-strength body 10 is annexed or disposed on the inner surface of the cylindrical sleeve body so as to be parallel with the axis thereof, and then, hot melt resin is applied over the tensile-strength body 10 and the inner surface of the sleeve body so as to form a hot melt resin layer 31 to provide a reinforcing sleeve 8. Alternatively, it is possible to form a predetermined cylindrical-shaped body made of hot melt resin and then insert the same in the sleeve body to provide a reinforcing sleeve 8. Further alternatively, a structure is possible in which the tensile-strength body 10 is directly embedded in the cylindrical sleeve body before or after the hot melt resin application.

On the other hand, a sheath of an outer or connection side section of the optical fiber cord 3 may be peeled to expose a coated optical fiber 32 and tensile-strength fiber bodies 11 and then the tip section of the coated optical fiber 32 may be decoated so as to provide an exposed section of the bare optical fiber 3a.

Then, as illustrated in FIG. 7, the thus-prepared optical fiber cord 3 is inserted in the aforesaid reinforcing sleeve 8.

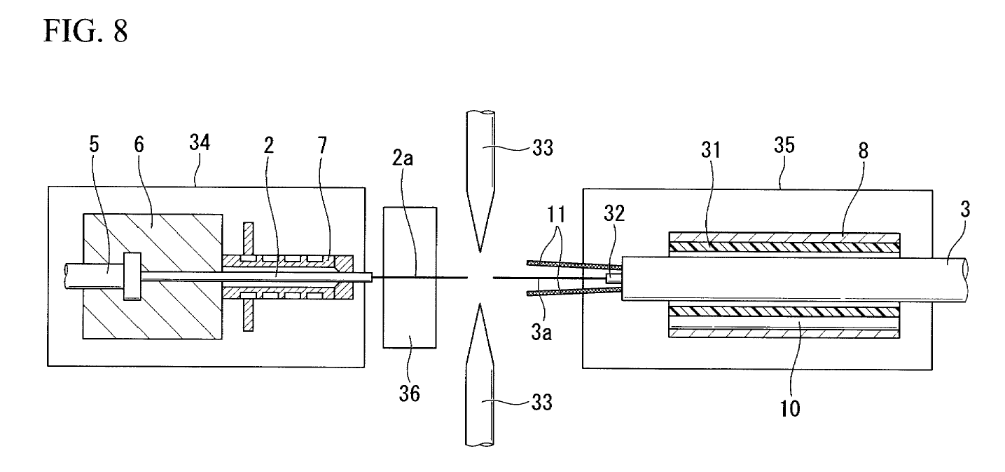

Next, as illustrated in FIG. 8, in a fusion-splicing apparatus, discharging electrodes 33 are disposed to oppose one another with a predetermined clearance therebetween. Holders 34 and 35 to be mounted on the fusion-splicing apparatus are prepared. The ferrule 5, the connector housing 6a, and the stop-ring structure 7 are fixedly secured at positions in the holder 34. The bare optical fiber 2a of the optical fiber 2 of the optical connector 6 is set in a V-shaped groove 36 of the fusion-splicing apparatus such that the bare optical fiber 2a is positioned.

The reinforcing sleeve 8 and the optical fiber cord 3 are fixedly secured at positions in the holder 35 and the bare optical fiber 3a is positioned.

Next, the holders 34 and 35 are placed in diametrically opposed positions with respect to the discharging electrodes 33 and the bare optical fibers 2a and 3a are positioned so as to abut one another. A predetermined high voltage is applied to the discharging electrodes 33 such that the abutting portions of the bare optical fibers are fusion-spliced or fused. Namely, the bare optical fiber 2a of the optical fiber 2 of the optical connector 6 and the bare optical fiber 3a of the optical fiber cord 3 are fused and connected to provide a fused connection portion 4.

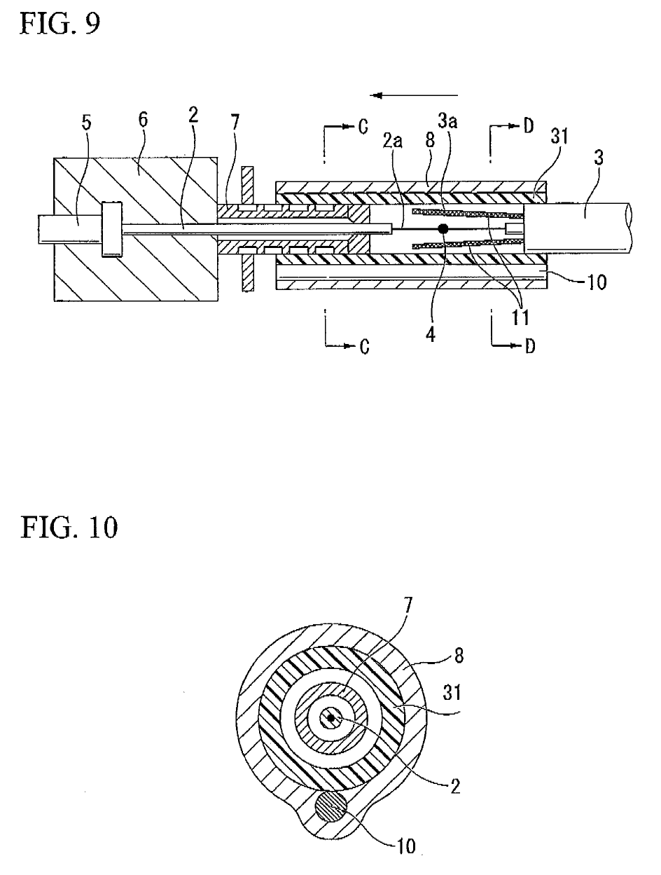

Next, as illustrated in FIGS. 9 to 11, the reinforcing sleeve 8 is moved or shifted to a position where it entirely encloses the fused connection portion and the exposed sections of the bare optical fibers 2a and 3a such that the reinforcing sleeve 8 abuts against the flange 7a of the stop-ring structure 7. With this construction or the simple abutting operation, it is possible to manage without precise positioning of the reinforcing sleeve 8.

Then, by using an unillustrated heater, the reinforcing sleeve 8 is heated to and maintained at a shrinkage temperature or more and the hot melt resin layer 31 is heated to and maintained at a melting temperature or more, so that the reinforcing sleeve 8 is contracted, and at the same time, the hot melt resin layer 31 is melted. Then, the thus-melted hot melt resin flows in and fills up the inside clearance, containing a space in each groove 21 of the stop-ring structure 7, of the reinforcing sleeve 8.

At this time, air residing in the reinforcing sleeve 8 is substantially discharged to the outside of the reinforcing sleeve 8 such that bubbles are not formed or remain therein.

Next, it is removed from the heater and then self-cooled to a temperature which is as the same as the shrinkage temperature of the reinforcing sleeve 8, which is lower than the melting temperature of the hot melt resin 31, and which is, for example, room temperature (e.g., 25 degrees centigrade). As a result, as illustrated in FIG. 12, the reinforcing sleeve 8 is contracted and the hot melt resin 31 is cured whereby the reinforcing sleeve 8, the thus-cured hot melt resin 9, and the stop-ring structure 7 are integrally and tightly combined.

Finally, the boot 13 is mounted so that the optical connector or connecting structure 1 of the present embodiment is completed.

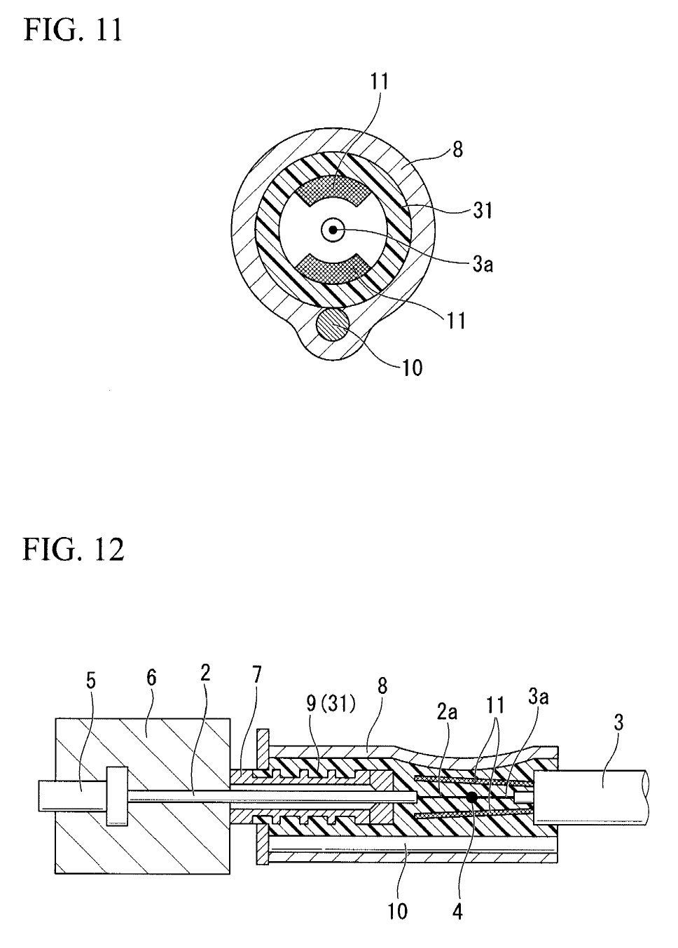

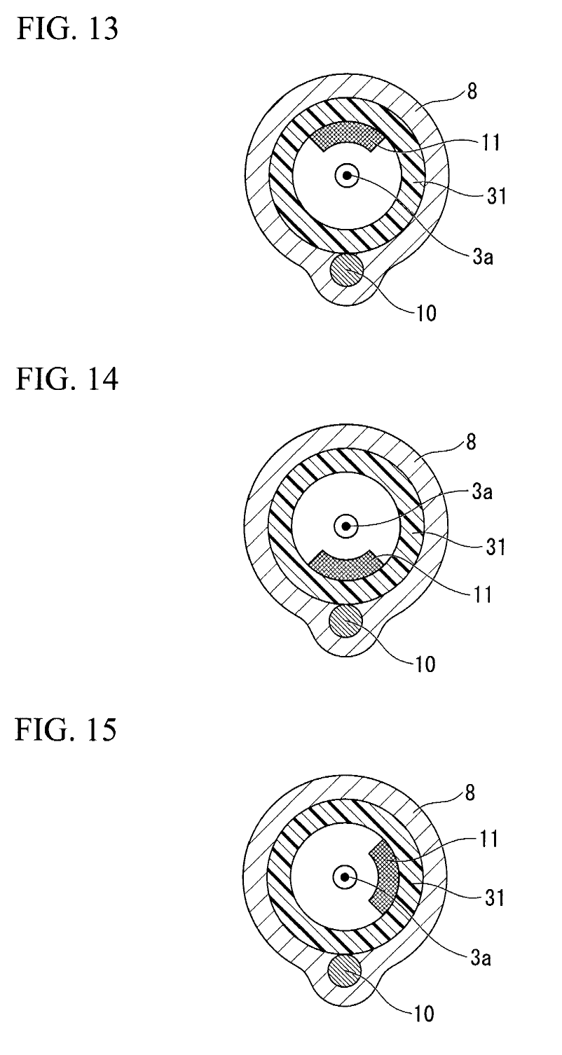

FIG. 13 is a cross sectional view illustrating a modified example of the tensile-strength fiber body 11 before heat shrinkage of the aforesaid embodiment. The structure of FIG. 13 is different from the structure of FIG. 11 in that the tensile-strength fiber body 11 having a generally fan or sector shape in cross section is solely provided at an upper side with respect to the fused connection portion 4.

FIG. 14 is a cross sectional view illustrating a modified example of the tensile-strength fiber body 11 before heat shrinkage of the aforesaid embodiment. The structure of FIG. 14 is different from the structure of FIG. 11 in that the tensile-strength fiber body 11 having a generally fan or sector shape in cross section is solely provided at a lower side with respect to the fused connection portion 4.

FIG. 15 is a cross sectional view illustrating a modified example of the tensile-strength fiber body 11 before heat shrinkage of the aforesaid embodiment. The structure of FIG. 15 is different from the structure of FIG. 11 in that the tensile-strength fiber body 11 having a generally fan or sector shape in cross section is solely provided at a right-hand side or left-hand side with respect to the fused connection portion 4.

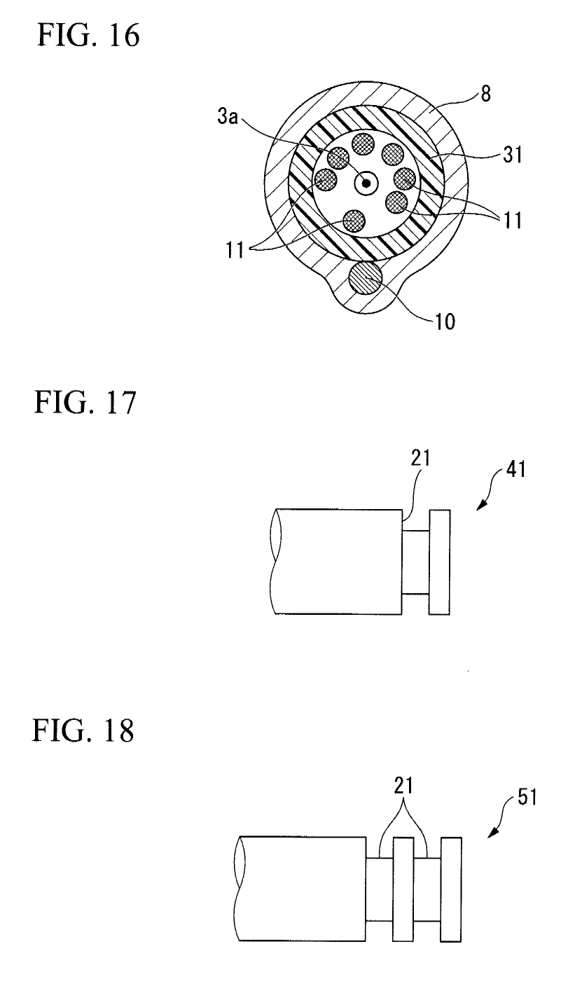

FIG. 16 is a cross sectional view illustrating a modified example of the tensile-strength fiber body 11 before heat shrinkage of the aforesaid embodiment. The structure of FIG. 16 is different from the structure of FIG. 11 in that the tensile-strength fiber bodies 11 having a generally fan or sector shape in cross section are disposed in an enclosing manner around the fused connection portion 4.

As described, various changes in general shape and disposition with regard to the tensile-strength fiber body 11 are possible, such as those described above and others, as would be understood by one of ordinary skill in the art. Even when such changes are included, it is possible to reduce stress applied to portions, in the fused connection portion 4 or the peripheral thereof, of the bare optical fibers 2a and 3a when heat shrinkage of the reinforcing sleeve 8 is generated and the hot melt resin 31 is hardened, and to thereby protect them.

FIG. 17 is a side view illustrating a modified example of the stop-ring structure 7 of the aforesaid embodiment. The modified stop-ring structure 41 of FIG. 17 is different from the stop-ring structure 7 of FIG. 1 in that a circumferential groove 21 is formed on a tip end thereof. For example, when the stop-ring structure 41 has a diameter of 4 mm and a length of 8 mm and the reinforcing sleeve 8 has a length of 34 mm, the circumferential groove 21 may be set to have a width of 2 mm and a depth of 2 mm and to be formed at a lengthwise directional position of 1.5 mm from the tip end face.

FIG. 18 is a side view illustrating a modified example of the stop-ring structure 7 of the aforesaid embodiment. The modified stop-ring structure 51 of FIG. 18 is different from the stop-ring structure 7 of FIG. 1 in that two circumferential grooves 21 are formed on a tip end thereof. For example, when the stop-ring structure 51 has a diameter of 4 mm and a length of 8 mm and the reinforcing sleeve 8 has a length of 34 mm, each of the circumferential grooves 21 may be set to have a width of 2 mm and a depth of 2 mm and the distance between them is set to be 1.5 mm.

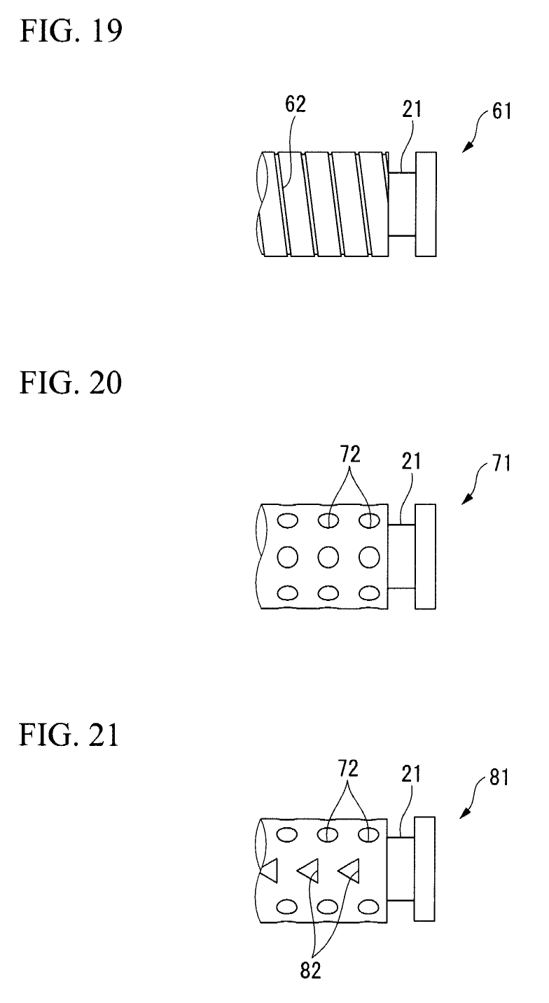

FIG. 19 is a side view illustrating a modified example of the stop-ring structure 7 of the aforesaid embodiment. The modified stop-ring structure 61 of FIG. 19 is different from the stop-ring structure 7 of FIG. 1 in that the circumferential groove 21 is formed on a tip end thereof and that a spiral groove 62 is formed on a body portion thereof. With the circumferential groove 21 and the spiral groove 62 provided in the stop-ring structure 61, the coefficient of friction between the stop-ring structure 61 and the reinforcing sleeve 8 is further increased and accordingly the tensile breaking strength is further improved.

FIG. 20 is a side view illustrating a modified example of the stop-ring structure 7 of the aforesaid embodiment. The modified stop-ring structure 71 of FIG. 20 is different from the stop-ring structure 7 of FIG. 1 in that the circumferential groove 21 is formed on a tip end thereof and that recessed portions 72, whose openings are of circular shape and whose cross sections are of arc-shape, are provided in a grid pattern on a peripheral surface of a body portion of the stop-ring structure 71. With the circumferential groove 21 and the recessed portions 72 of the body portion provided in the stop-ring structure 71, the coefficient of friction between the stop-ring structure 71 and the reinforcing sleeve 8 is further increased and accordingly the tensile breaking strength is further improved.

FIG. 21 is a side view illustrating a modified example of the stop-ring structure 7 of the aforesaid embodiment. The thus-illustrated stop-ring structure 81 is different from the stop-ring structure 7 of FIG. 1 in that the circumferential groove 21 is formed on a tip end thereof, that a plurality of lines (parallel to the center axis) of recessed portions 72 (whose openings are of circular shape and whose transverse cross sections are of arc-shape) are formed on the outer peripheral surface of the body portion, and that, between the lines of the recessed portions 72, and that another plurality of lines (parallel to the center axis) of recessed portions 82 (whose openings are of triangular shape and whose transverse cross sections are of rectangular shape) are formed. With the circumferential groove 21 and the recessed portions 72 and 82 of the body portion provided in the stop-ring structure 81, the coefficient of friction between the stop-ring structure 81 and the reinforcing sleeve 8 is further increased and accordingly the tensile breaking strength is further improved.

As described above, according to the optical connector connecting apparatus 1 of this embodiment, it is possible to firmly secure the fused connection portion 4 of the optical fibers and the reinforcing sleeve 8 without a clearance being generated therebetween, to make workability easy, and to reduce the production cost.

It is also possible for the fused connection portion 4 of the optical fibers, the reinforcing sleeve 8, the cured hot melt resin 9, and the tensile-strength body 10 to be tightly and integrally solidified.

Incidentally, in the aforesaid exemplary embodiment, the reinforcing sleeve 8 abuts the flange 7a of the stop-ring structure 7 and thereafter the reinforcing sleeve 8 is contracted or shrunk such that the cured resin 9 and the stop-ring structure 7 are integrally connected. Alternatively, a structure is possible in which there is a clearance between the reinforcing sleeve 8 and the flange 7a of the stop-ring structure 7.

Further, the numbers or shapes of the grooves 21 of the stop-ring structure 7, the pitch and the depth of the spiral groove 62, the shapes, the dimensions and the numbers of the recessed portions 72 and 82, and the like, are appropriately selected according to need. The invention is not limited to those disclosed in the Figures.

Furthermore, although the concave portions or recessed portions 72 and 82 are provided in the present embodiment, they can be replaced with unillustrated convex portions by which similar effects can be obtained.

While the invention has been particularly shown and described with reference to an exemplary embodiment thereof, the invention is not limited to the exemplary embodiment. It will be understood by those of ordinary skill in the art that various changes in form and details may be made therein without departing from the scope of the invention as defined by the following claims.

What is claimed is:

1. A method of connecting an optical connector and an optical fiber cord, comprising:
providing an optical connector comprising a connector housing, a stop-ring structure, and a first optical fiber which extends through the connector housing and the stop-ring structure and protrudes from a structure end of the stop-ring structure toward a connection side;
fusion-splicing a fiber end of the first optical fiber and a fiber end of a second optical fiber which protrudes from a cord end of the optical fiber cord; enclosing the cord end of the optical fiber cord and at least the structure end of the stop-ring structure with a reinforcing sleeve, wherein the reinforcing sleeve comprises an annular sleeve body, a hot melt resin layer applied to an inner surface of the sleeve body, and a tensile-strength body embedded in one of the annular sleeve body and the hot melt resin layer; and heating and heat-releasing the reinforcing sleeve such that the hot melt resin layer is melted into a molten resin which fills an inner space of the reinforcing sleeve, and solidifies therein.

2. The method as recited in claim 1, wherein the tensile-strength body is substantially parallel with an axis of the annular sleeve body.

3. The method as recited in claim 1, wherein the first optical fiber is fixedly secured to an inner portion of the structure end of the stop-ring structure.

4. The method as recited in claim 1, wherein the optical fiber cord comprises at least one tensile-strength fiber body which extends through the optical fiber cord.

5. The method as recited in claim 1, wherein the stop-ring structure comprises a concave portion or a convex portion formed on an outer peripheral surface of the stop-ring structure.

6. An optical connector formed by the method as recited in claim 1.

7. The method as recited in claim 5, wherein the concave portion or the convex portion comprises:
a circumferential groove.

8. The method as recited in claim 5, wherein the concave portion or the convex portion comprises:
a circumferential groove; and
a spiral groove along a length of the stop-ring structure.

9. The method as recited in claim 1, wherein the stop-ring structure comprises:
a plurality of recessed portions having circular openings and arc-shaped cross-sections.

10. The method of claim 1, wherein the stop-ring structure comprises:
a first plurality of recessed portions having circular openings and arc-shaped cross-sections, wherein the first plurality of recessed portions are arranged along a first plurality of lines parallel to a center axis of the stop-ring structure;
a second plurality of recessed portions having triangular openings and rectangular cross-sections, and wherein the second plurality of recessed portions are arranged along a second plurality of lines parallel to the center axis of the stop-ring structure and alternating with the first plurality of lines.

11. A fusion-spliced optical fiber apparatus, comprising:
an optical connector comprising a connector housing, a stop-ring structure, and a first optical fiber which extends through the connector housing and the stop-ring structure and protrudes from a structure end of the stop ring structure toward a connection side;
an optical fiber cord and a second optical fiber which protrudes from a cord end of the optical fiber cord, wherein an end of the second optical fiber is fusion-spliced to an end of the first optical fiber;
a reinforcing sleeve which encloses the cord end of the optical fiber cord and at least the structure end of the stop-ring structure, wherein
the reinforcing sleeve comprises:
an annular sleeve body;
a resin which fills an inner space of the reinforcing sleeve and integrates the cord end of the optical fiber cord and the stop-ring structure; and
a tensile-strength body embedded in one of the annular sleeve body and the resin.

12. The fusion-spliced optical fiber apparatus as recited in claim 11, wherein the tensile-strength body is substantially parallel with an axis of the annular sleeve body.

13. The fusion-spliced optical fiber apparatus as recited in claim 11, wherein the first optical fiber is fixedly secured to an inner portion of the structure end of the stop-ring structure.

14. The fusion-spliced optical fiber apparatus as recited in claim 11, wherein the optical fiber cord comprises at least one tensile-strength fiber body which extends through the optical fiber cord.

15. The fusion-spliced optical fiber apparatus as recited in claim 11, wherein the stop-ring structure comprises a concave portion or a convex portion formed on an outer peripheral surface of the stop-ring structure.

16. The fusion-spliced optical fiber apparatus as recited in claim 15, wherein the concave portion or the convex portion comprises:
a circumferential groove.

17. The fusion-spliced optical fiber apparatus as recited in claim 15, wherein the concave portion or the convex portion comprises:
a circumferential groove; and
a spiral groove along a length of the stop-ring structure.

18. The fusion-spliced optical fiber apparatus as recited in claim 11, wherein the stop-ring structure comprises:
a plurality of recessed portions having circular openings and arc-shaped cross-sections.

19. The fusion-spliced optical fiber apparatus as recited in claim 11, wherein the stop-ring structure comprises:
a first plurality of recessed portions having circular openings and arc-shaped cross-sections, wherein the first plurality of recessed portions are arranged along a first plurality of lines parallel to a center axis of the stop-ring structure;
a second plurality of recessed portions having triangular openings and rectangular cross-sections, and wherein the second plurality of recessed portions are arranged along a second plurality of lines parallel to the center axis of the stop-ring structure and alternating with the first plurality of lines.
